(19) United States
(12) Patent Application Publication
(10) Pub. No.: US 2014/0362406 A1
(43) Pub. Date: Dec. 11, 2014

(54) IMAGE PROCESSING SYSTEM, IMAGE PROCESSING METHOD, INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: Atsushi Ikeda, Tokorozawa-shi (JP)

(21) Appl. No.: 14/297,462

(22) Filed: Jun. 5, 2014

(30) Foreign Application Priority Data
Jun. 10, 2013 (JP) 2013-121842

(51) Int. Cl. H04N 1/00

(52) U.S. Cl. CPC H04N 1/00095; H04N 1/00129; H04N 2201/0094; H04N 2201/0089; H04N 2201/0096
USPC 358/1.15

(57) ABSTRACT

There is provided an image processing system which merges image data transmitted from a tablet terminal with image data generated by reading a document and transmits the merged image data in one outgoing call, when both of an image transmission command and a scan command are received from the tablet terminal.

### BACKGROUND OF THE INVENTION

1. Field of the Invention

The present invention relates to an image processing system which transmits image data generated by reading received image data and a document.

2. Description of the Related Art

Until now, there has been known a function in which a client computer generates image data and transmits it to a facsimile machine via a local area network (LAN). The facsimile machine transmits the received data as a facsimile message. In this case, the address of facsimile transmission can be designated by a user on a personal computer side.

There has been also known a function in which the facsimile machine is notified of only the address designated by the user and the image data is not prepared on the client computer side. Instead, the image data generated by the facsimile machine which reads a document is faxed to the designated address (refer to Japanese Patent Application Laid-Open NO. 7-288625).

For example, there may be a case where a user desires to fax both of a cover page generated by the client computer and the image data acquired by the facsimile machine reading a document. However, with the technique discussed in Japanese Patent Application Laid-Open NO. 7-288625, both of the image data generated by the client computer and the image data generated by the facsimile machine cannot be transmitted. In other words, in the technique discussed in Japanese Patent Application Laid-Open NO. 7-288625, the cover page generated by the client computer is first faxed and then the facsimile transmission of the image data generated by reading the document needs to be separately instructed. In this case, operation for transmitting the cover page and operation for transmitting the image data of the document need to be separately performed, which causes a burdensome task to a user.

### SUMMARY OF THE INVENTION

According to an aspect of the present invention, an image processing system includes a reception unit configured to receive image data transmitted by an information processing apparatus, a reading unit configured to read a document to generate image data, and a transmission unit configured to transmit both of the image data received by the reception unit and the image data generated by the reading unit, according to an instruction received by the information processing apparatus.

Further features of the present invention will become apparent from the following description of exemplary embodiments with reference to the attached drawings.

### BRIEF DESCRIPTION OF THE DRAWINGS

FIG. 1 is a general view of a network according to an exemplary embodiment of the present invention.

FIG. 2 is a hardware block diagram of a multifunction peripheral (MFP) according to the exemplary embodiment of the present invention.

FIG. 3 is a software block diagram of the MFP according to the exemplary embodiment of the present invention.

FIG. 4 is a hardware block diagram of a tablet terminal according to the exemplary embodiment of the present invention.

FIG. 5 illustrates an operation screen of the tablet terminal according to the exemplary embodiment of the present invention.

FIG. 6 is a sequence diagram according to the exemplary embodiment of the present invention.

FIG. 7 illustrates an operation screen of the tablet terminal according to the exemplary embodiment of the present invention.

FIG. 8 illustrates an operation screen of the tablet terminal according to the exemplary embodiment of the present invention.

FIG. 9 is a sequence diagram according to the exemplary embodiment of the present invention.

FIG. 10 is a sequence diagram according to the exemplary embodiment of the present invention.

FIG. 11 is a flow chart illustrating the operation of the MFP according to a conventional technique.

FIG. 12 illustrates an operation screen of the tablet terminal according to the exemplary embodiment of the present invention.

FIG. 13 is a sequence diagram according to the exemplary embodiment of the present invention.

FIG. 14 is a flow chart illustrating the operation of the MFP according to a conventional technique.

### DESCRIPTION OF THE EMBODIMENTS

Various exemplary embodiments, features, and aspects of the invention will be described in detail below with reference to the drawings.

The present exemplary embodiment described below does not limit the invention according to claims. All of combinations of characteristics described in the exemplary embodiment are not always essential as means for solving the problem of the invention.

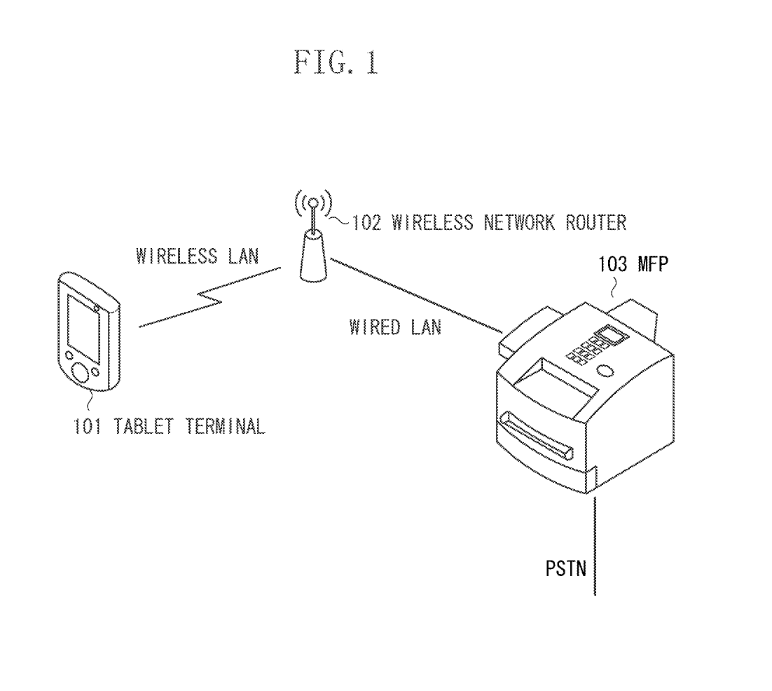

A first exemplary embodiment of the present invention is described below. FIG. 1 is a general view of a network. A tablet terminal 101 which is an example of an information processing apparatus communicates with a multifunction peripheral (MFP) 103 via a wireless network router (a wireless access point) 102. The MFP 103 is an example of an image processing apparatus. The MFP 103 itself may be referred to as an image processing system, or the MFP 103 and the tablet terminal 101 as a whole may be referred to as an image processing system. The tablet terminal 101 is connected with the wireless network router 102 via a wireless local area network (LAN). The MFP 103 is connected with the wireless network router 102 via a wired LAN. The MFP 103 is also connected with a public switched telephone network (PSTN).

Communication pathways of the tablet terminal 101 and the MFP 103 are not always limited to the above pathways. For example, the tablet terminal 101 may be connected with the wireless network router 102 via a wired LAN. The MFP 103 may be connected with the wireless network router 102 via a wireless LAN. The tablet terminal 101 and the MFP 103 may be connected with the same network.

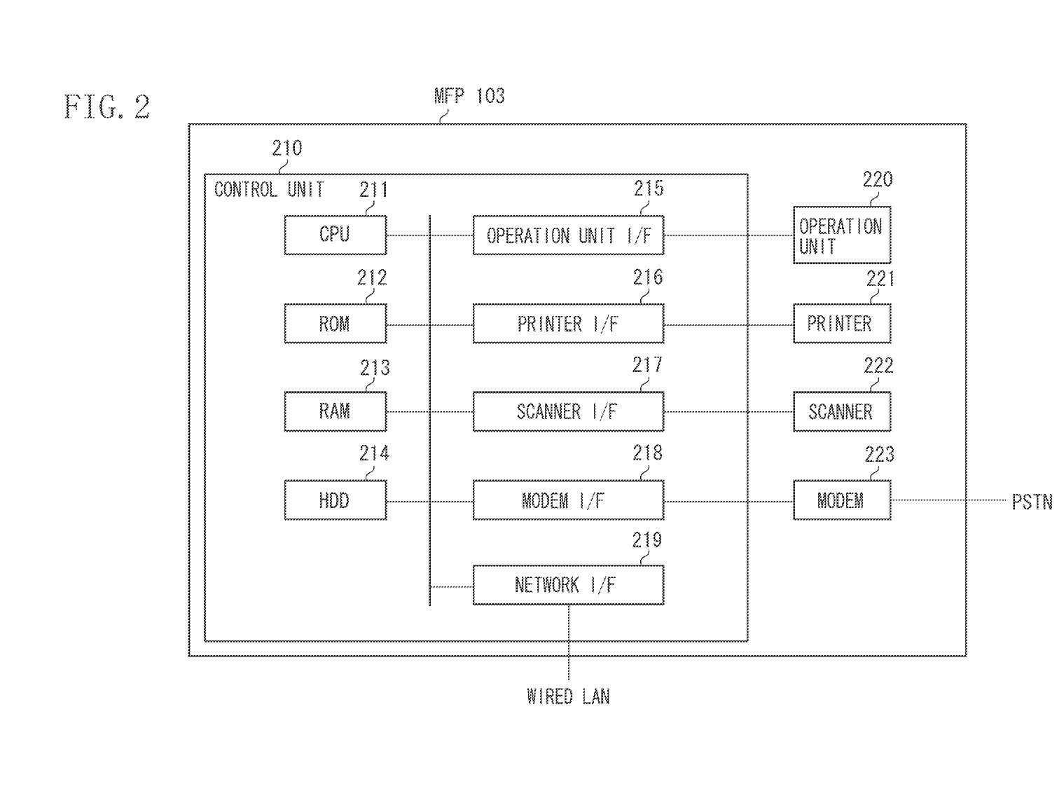

FIG. 2 is a hardware block diagram of the MFP 103. A control unit 210 including a central processing unit (CPU) 211 controls the entire MFP 103. The CPU 211 reads control programs stored in a read only memory (ROM) 212 to perform various controls such as reading, printing, and communication. The random access memory (RAM) 213 is used as a temporal storage area such a main memory and a work area of the CPU 211. In the MFP 103, one CPU 211 uses one memory (the RAM 213 or a hard disk drive (HDD) 214) to execute each processing illustrated in a flow chart described below, however, another configuration may be used. For example, a plurality of CPUs may collaborate with a plurality of RAMs or HDDs to execute each processing illustrated in the flow chart.

The HDD 214 stores image data and various programs. An operation unit interface (I/F) 215 connects the control unit 210 with an operation unit 220. The operation unit 220 includes a liquid crystal display with a touch panel function and a keyboard, and serves as a receiving unit for receiving an operation, input, and designation from a user.

A printer interface (I/F) 216 connects the control unit 210 with a printer 221. Image data to be printed by the printer 221 are transferred from the control unit 210 via the printer I/F 216 and printed on a recording medium by the printer 221.

A scanner interface (I/F) 217 connects the control unit 210 with a scanner 222. The scanner 222 reads an image on a document to generate image data and inputs the image data to the control unit 210 via the scanner I/F 217.

A modem interface (I/F) 218 connects the control unit 210 with a modem 223. The modem 223 is connected with the PSTN and executes facsimile communication of the image data with a facsimile machine (not illustrated). A network interface (I/F) 219 connects the control unit 210 (MFP 103) with the wired LAN. The MFP 103 can transmit and receive image data and various pieces of information from an external apparatus using the network I/F 219.

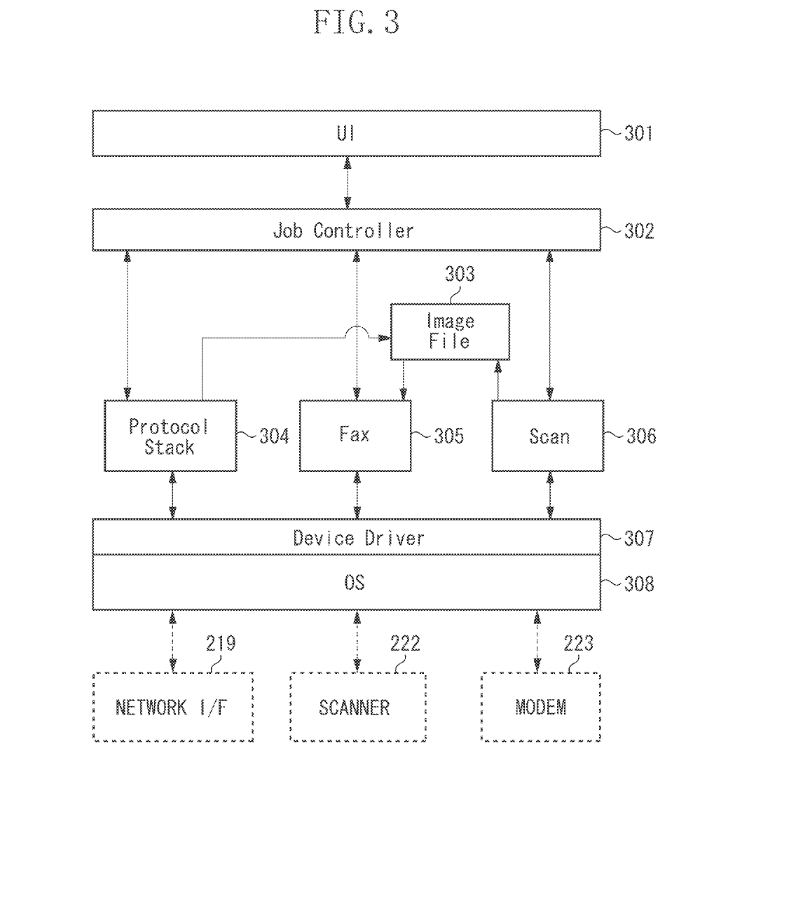

FIG. 3 is a software block diagram of the MFP 103. Each unit indicated by a solid line is a software module realized by the CPU 211 reading the programs stored in the ROM 212 or the HDD 214. A user interface (UI) unit 301 provides the user with the various pieces of information via the operation unit 220 and receives various instructions from the user. A job controller unit 302 receives jobs such as copy, print, and facsimile, and controls the execution of the received jobs. A protocol stack unit 304 stores various network protocols such as a transmission control protocol/internet protocol (TCP/IP) and a hypertext transfer protocol (HTTP).

In the present exemplary embodiment, the image data transmitted from the tablet terminal 101 are received via the network I/F 219 in accordance with the network protocol stored in the protocol stack unit 304. The received image data are stored by an image file unit 303. The image file unit 303 is a software module for managing the image data stored in the RAM 213 and the HDD 214.

The image file unit 303 stores the image data generated by the scanner 222 as well as the image data received via the network I/F 219. The generation of image data by the scanner 222 is controlled by a scan unit 306. The facsimile unit 305 controls facsimile communication to be conducted via the modem 223. When the MFP 103 transmits a facsimile message, the facsimile unit 305 reads the image data stored in the image file unit 303 and transmits the image data.

An operating system (OS) unit 308 coordinates each module and task and manages the entire software of the MFP 103. A device driver unit 307 is incorporated into the OS unit 308. The device driver unit 307 controls hardware devices such as the scanner 222 and the modem 223.

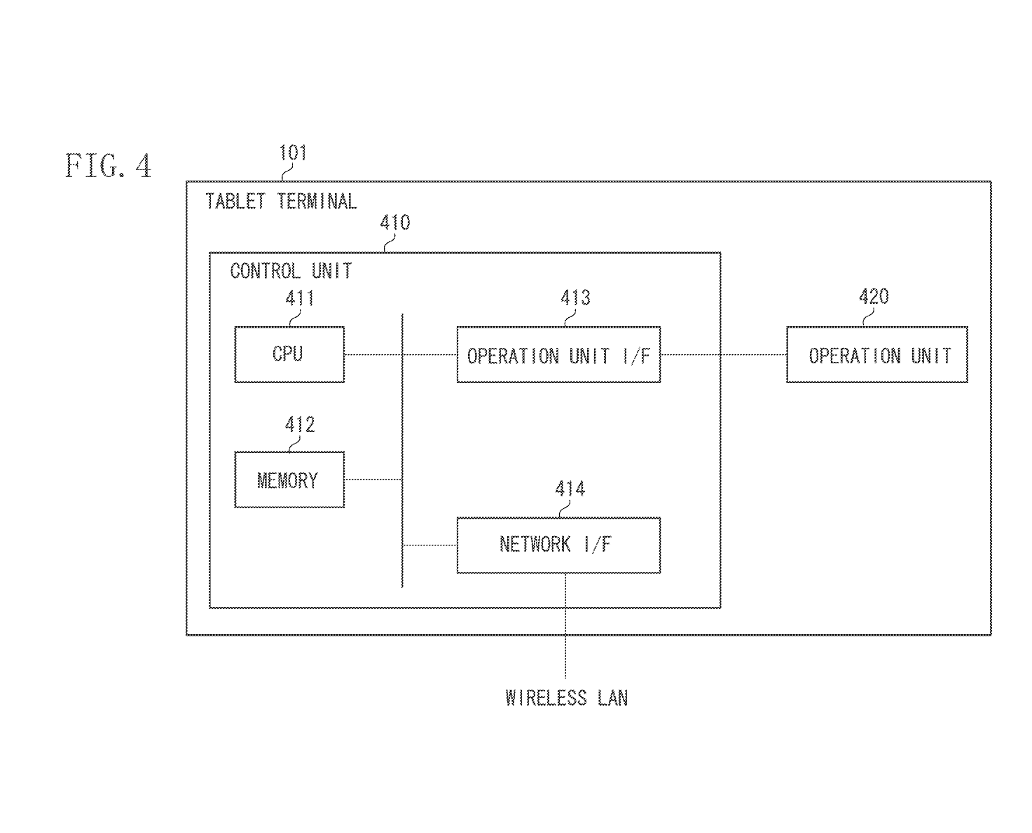

FIG. 4 is a hardware block diagram of the tablet terminal 101. A control unit 410 including a CPU 411 controls the operation of the entire tablet terminal 101. The CPU 411 reads control programs stored in a memory 412 to perform various controls. The memory 412 is also used as a temporal storage area such as a main memory and a work area of the CPU 411. In the tablet terminal 101, one CPU 411 uses one memory 412 to execute each processing, however, another configuration may also be used. For example, a plurality of CPUs or a plurality of memories may collaborate to execute each processing.

An operation unit I/F 413 connects the control unit 410 with an operation unit 410. The operation unit 420 includes a liquid crystal display with a touch panel function and serves as a unit for receiving an operation, inputting, and an instruction from the user. A network I/F 414 connects the control unit 410 (the tablet terminal 101) with a wired LAN. The tablet terminal 101 can transmit image data to an external apparatus using the network I/F 414 and receive various pieces of information.

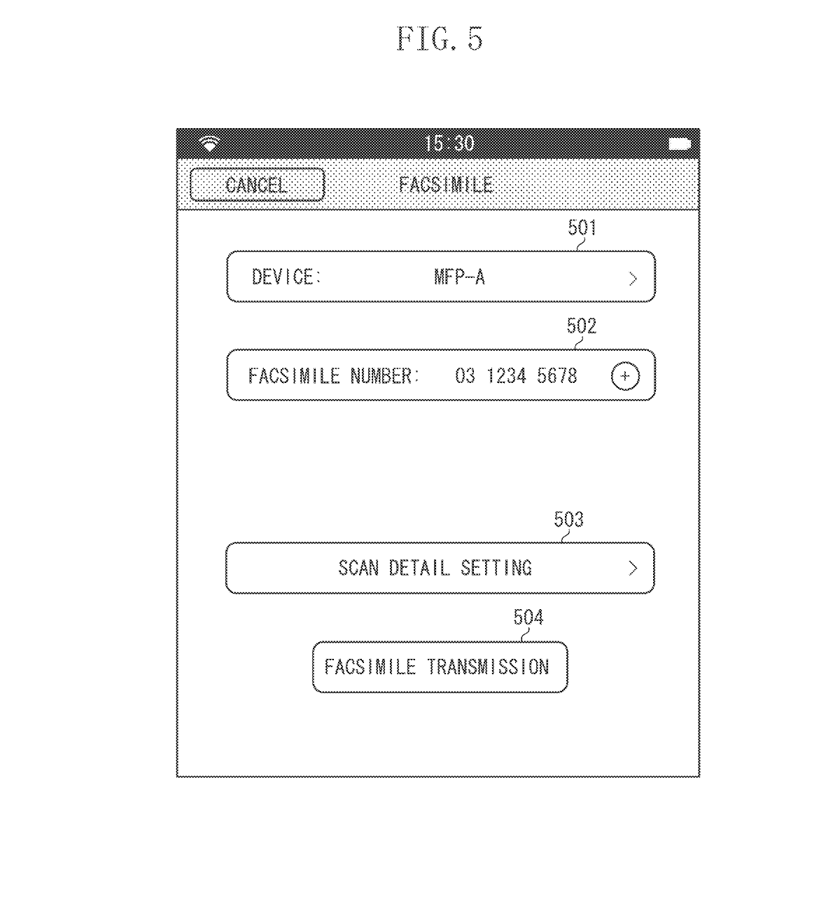

FIG. 5 illustrates an operation screen of a facsimile transmission application displayed on the tablet terminal 101. The facsimile transmission application can be downloaded from a server on the Internet and additionally installed on the tablet terminal 101. The facsimile transmission application is operated on the OS unit 308. With the use of the facsimile transmission application, the tablet terminal 101 can make a setting to cause the MFP 103 to transmit a facsimile message. The operation of the tablet terminal 101 described below is executed based on the instruction from the facsimile transmission application.

When the facsimile transmission application is activated by the tablet terminal 101, the operation screen illustrated in FIG. 5 is displayed. A setting field 501 is a field where the MFP for executing facsimile transmission is set. Touching the setting field 501 causes the tablet terminal 101 to search for an MFP around the tablet terminal 101 and displays a list of MFPs which it has found. The user can select the MFP for executing facsimile transmission from among the displayed MFPs.

A setting field 502 is a field where a telephone number (a facsimile number) as the destination of the facsimile message is set. The user may input a telephone number using a soft keyboard displayed on the tablet terminal 101 or select a telephone number with reference to an address book stored in the tablet terminal 101.

A setting field 503 is a field where a detailed setting of scan processing (reading processing) to be executed using the scanner 221 of the MFP 103 is made. When a user touches the setting field 503, a screen for specifying reading parameters such as resolution, document size, and color/monochrome is displayed and the scanning setting is received via the screen.

A facsimile transmission key 504 is a key for instructing the MFP 103 to transmit facsimile massage. When a facsimile transmission key 504 is pressed after the setting fields 501 to 503 are set, communication starts between the tablet terminal 101 and the MFP 103.

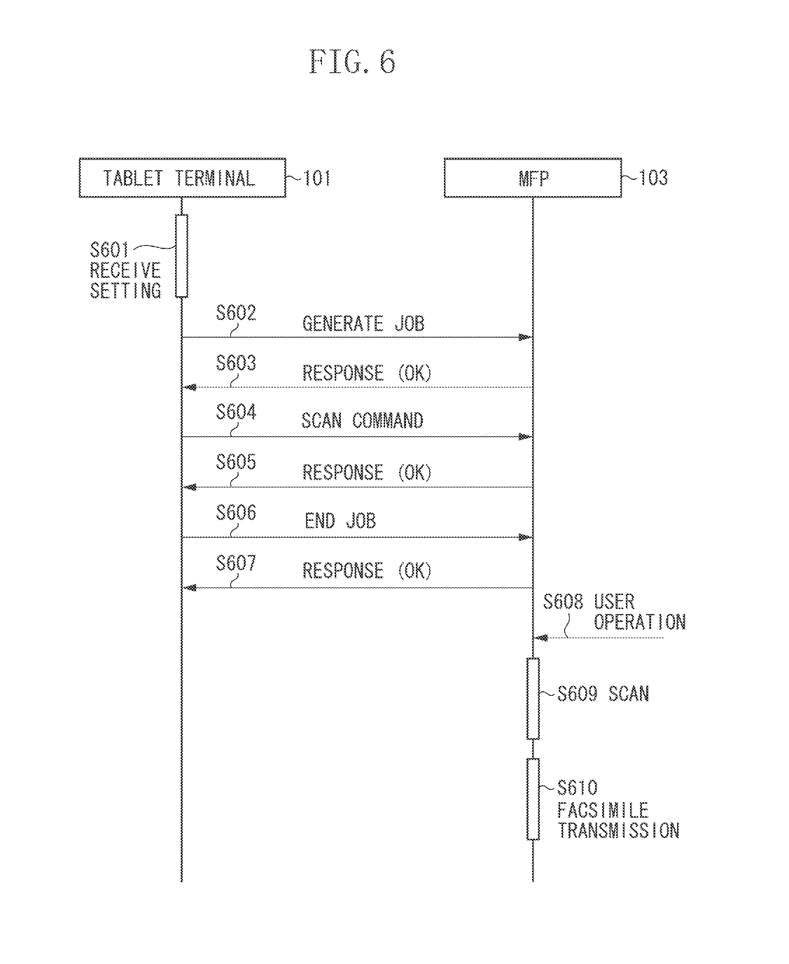

FIG. 6 is a sequence diagram for processing in the tablet terminal 101 and the MFP 103. In step S601, the user's setting via the operation screen illustrated in FIG. 5 is received from the user. In step S602, the tablet terminal 101 transmits a job generation command to the MFP 103. In step S603, the MFP 103 which has received the command returns an OK response to the tablet terminal 101.

In step S604, the tablet terminal 101 transmits to the MFP 103 a scan command instructing the MFP 103 to execute scanning. In step S605, the MFP 103 which has received the command confirms that the scanner 222 is available and then sends the OK response to the tablet terminal 101.

In step S606, the tablet terminal 101 transmits a job end command to the MFP 103. In step S607, the MFP 103 which has received the command returns the OK response to the tablet terminal 101.

The MFP 103 waits until the user performs operation and, in step S608, when the MFP 103 receives the user's operation, the MFP 103 proceeds to step S609. In step S609, the MFP 103 performs scan processing on a document using the scanner 222. The processing is performed according to the contents set in the setting field 503. In step S610, the MFP 103 faxes the image data acquired by the scanning in step S609. The address of the facsimile transmission is the telephone number set in the setting field 502.

As described above, the MFP 103 scans the document and faxes the acquired image data according to the contents set in the tablet terminal 101. Hereinafter, the processing is referred to as a first transmission processing. In the first transmission processing, only the image data acquired by scanning of the MFP 103 are faxed. In a second transmission processing described below, on the other hand, the image data prepared by the tablet terminal 101 are faxed from the MFP 103.

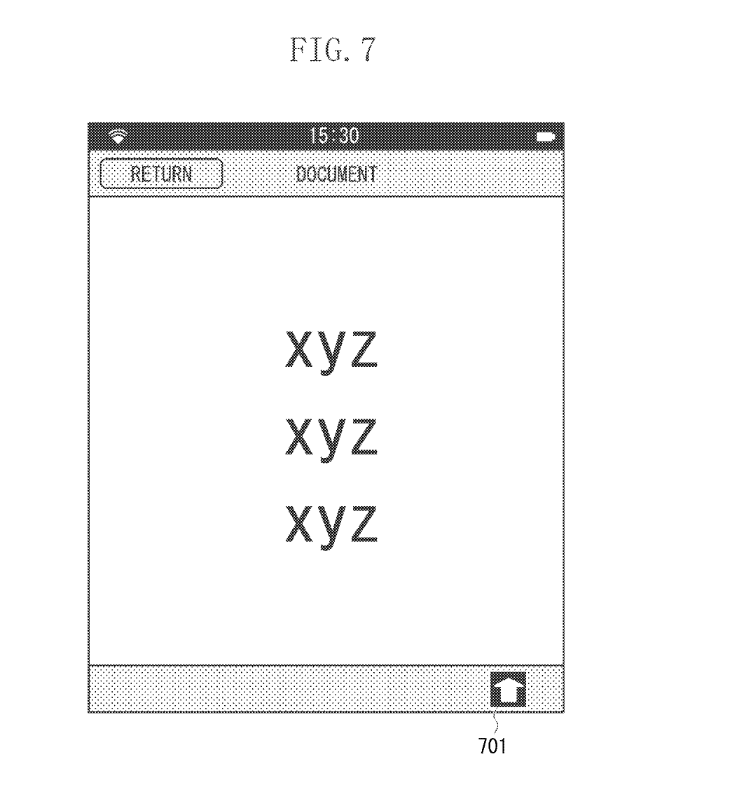

FIG. 7 illustrates the operation screen of a data management application displayed on the tablet terminal 101. The tablet terminal 101 stores the image data downloaded from the network and the image data captured using a camera function included in the tablet terminal 101. The image data can be sequentially displayed by switching, with the use of the data management application installed in the tablet terminal 101. The operation screen illustrated in FIG. 7 displays one of the stored image data.

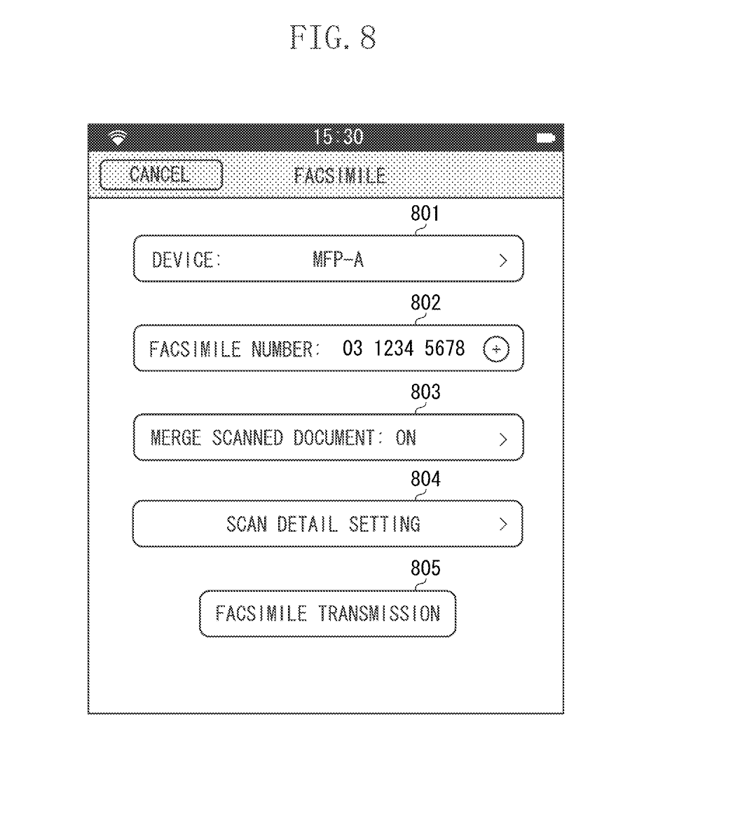

When the user presses an operation key 701 on the operation screen illustrated in FIG. 7, a screen for selecting a function to be applied to the image data currently displayed is displayed. The screen displays the above facsimile transmission application as a selection candidate in addition to a mail transmission application and a print application. When the user selects the facsimile transmission application, an operation screen illustrated in FIG. 8 appears.

FIG. 8 illustrates the operation screen of the facsimile transmission application displayed on the tablet terminal 101. Setting fields 801, 802, and 804 are similar to the setting fields 501, 502, and 503 described in FIG. 5 respectively. A facsimile transmission key 805 is similar to the facsimile transmission key 504 described in FIG. 5.

It can be seen that a setting field 803 is added if the operation screen in FIG. 8 is compared with the operation screen in FIG. 5. In the setting field 803, setting is made as to whether only the image data selected in the operation screen in FIG. 7 are faxed from the MFP 103 or both of the image data selected in the operation screen in FIG. 7 and the image data acquired by scanning of the MFP 103 are faxed from the MFP 103. Hereinafter, the former processing is referred to as second transmission processing. The latter processing is referred to as third transmission processing.

In the setting field 803, “ON” or “OFF” can be selected. By setting “OFF”, the second transmission processing is executed. By setting “ON”, the third transmission processing is executed.

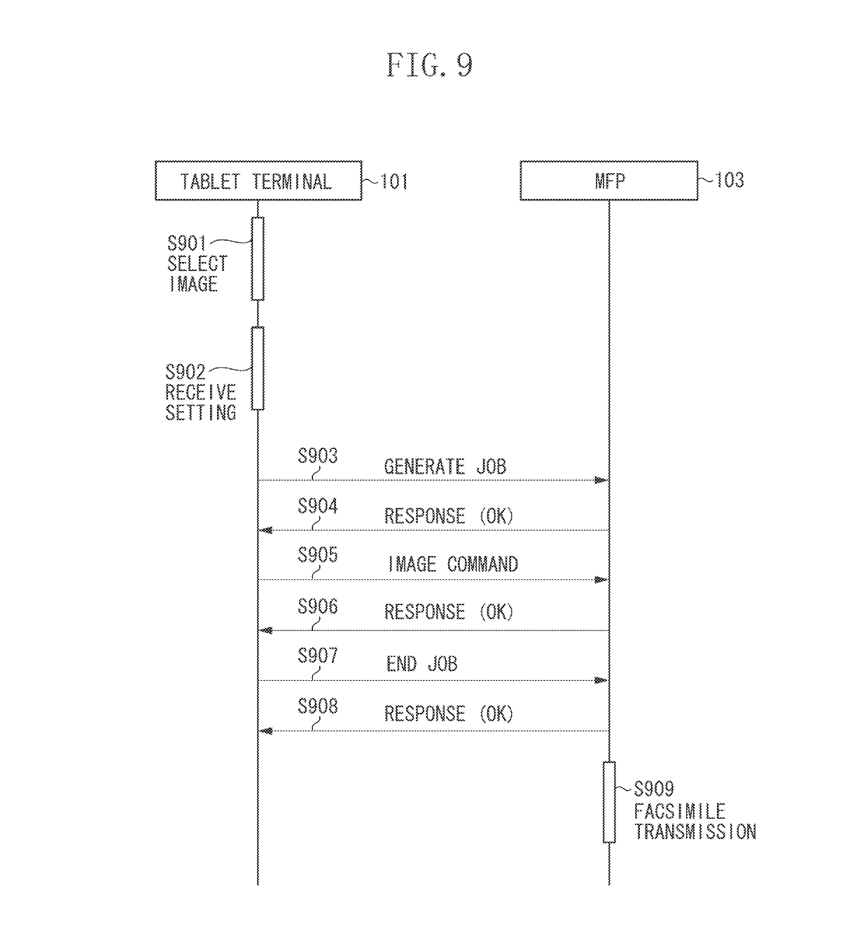

FIG. 9 is a sequence diagram in a case where “OFF” is set in the setting field 803 (in a case where the second transmission processing is executed). In step S901, the tablet terminal 101 receives the image selection from the user via the operation screen in FIG. 7. In step S902, the tablet terminal 101 receives the setting from the user via the operation screen in FIG. 8. In second transmission processing, the MFP 103 does not execute the scan processing, so that the setting field 804 may be displayed in gray-out.

In step S903, the tablet terminal 101 transmits the job generation command to the MFP 103. In step S904, the MFP 103 which has received the command returns the OK response to the tablet terminal 101.

In step S905, the tablet terminal 101 transmits the image transmission command to the MFP 103. The image transmission command includes image data to be faxed from the MFP 103. The image data is data displayed on the operation screen illustrated in FIG. 7. In step S906, the MFP 103 which has received the image transmission command returns the OK response to the tablet terminal 101.

In step S907, the tablet terminal 101 transmits the job end command to the MFP 103. In step S908, the MFP 103 which has received the command returns the OK response to the tablet terminal 101.

In step S909, the MFP 103 faxes the image data received from the tablet terminal 101. The address of the facsimile transmission is the telephone number set in the setting field 802. In the second transmission processing, the MFP 103 does not execute the scan processing. For this reason, unlike the first transmission processing, the user does not need to wait for the operation of the MFP 103.

As described above, the processing (the second transmission processing) is performed in which the image data transmitted from the tablet terminal 101 to the MFP 103 are faxed from the MFP 103 according to the information set by the tablet terminal 101. The third transmission processing is described below.

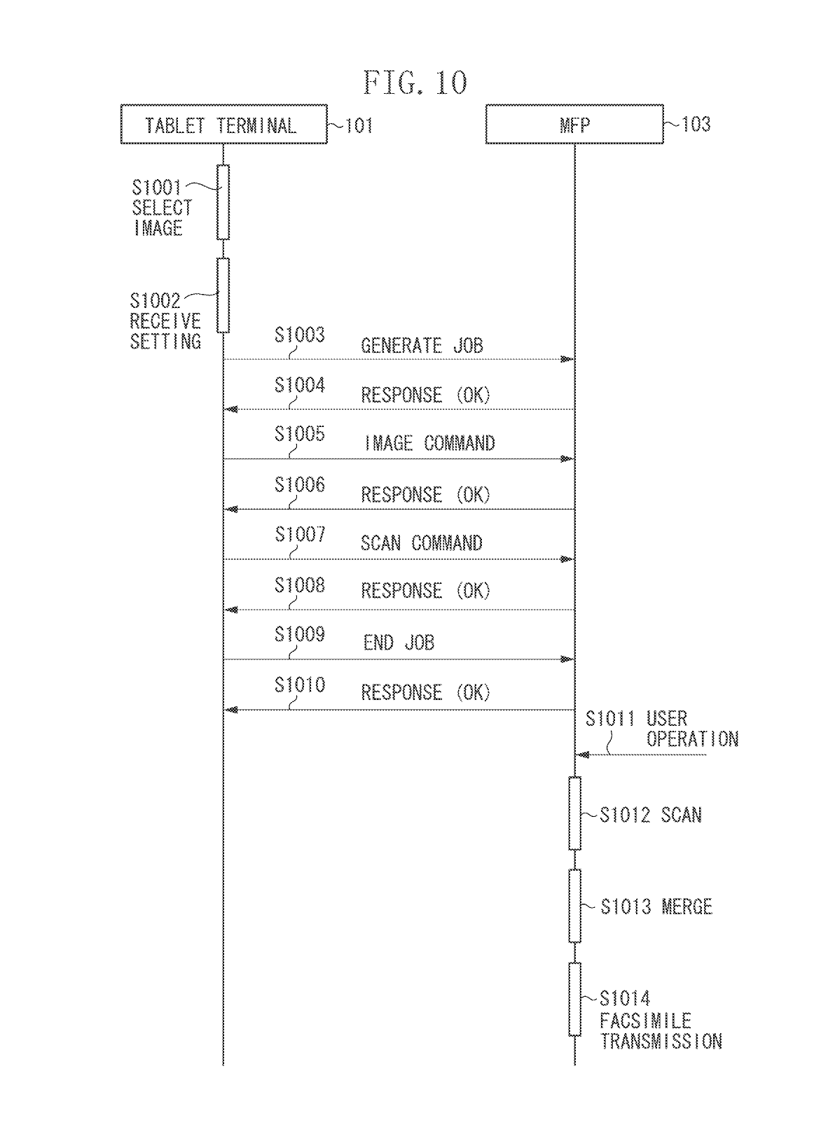

FIG. 10 is a sequence diagram in a case where the facsimile transmission key 805 illustrated in FIG. 8 is pressed with “ON” being set in the setting field 803 (in a case where the third transmission processing is executed).

In step S1001, the tablet terminal 101 receives the image selection from the user via the operation screen in FIG. 7. In step S1002, the tablet terminal 101 receives the setting from the user via the operation screen in FIG. 8. In step S1003, the tablet terminal 101 transmits the job generation command to the MFP 103. In step S1004, the MFP 103 which has received the command returns the OK response to the tablet terminal 101.

In step S1005, the tablet terminal 101 transmits the image transmission command to the MFP 103. The image transmission command includes image data to be faxed from the MFP 103. The image data is the data displayed on the operation screen illustrated in FIG. 7. In step S1006, the MFP 103 which has received the image transmission command returns the OK response to the tablet terminal 101.

In step S1007, the tablet terminal 101 transmits the scan command to instruct the MFP 103 to execute scanning to the MFP 103. In step S1008, the MFP 103 which has received the command confirms that the scanner 222 is available and then sends the OK response to the tablet terminal 101.

In step S1009, the tablet terminal 101 transmits the job end command to the MFP 103. In step S1010, the MFP 103 which has received the command returns the OK response to the tablet terminal 101.

The MFP 103 waits until the user performs operation and, in step S1011, when the MFP 103 receives the user's operation, the MFP 103 proceeds to step S1012. In step S1012, the MFP 103 performs scan processing of a document using the scanner 222. The processing is performed according to the information set in the setting field 804. In step S1013, the image data transmitted from the tablet terminal 101 in step S1005 and the image data acquired in step S1012 are merged together. The term “merge” means that a plurality of image data is turned into one piece of image data comprised of a plurality of pages (it may be referred to as a document or a document file). In step S1014, the MFP 103 faxes the image data merged in step S1013. The address of the facsimile transmission is the telephone number set in the setting field 802.

As described above, the processing is performed in which the image data transmitted from the tablet terminal 101 to the MFP 103 and the image data acquired by scanning of the MFP 103 are merged together according to the information set by the tablet terminal 101 and the MFP 103 faxes the merged data. For example, the third transmission processing is used in a case where the cover page generated by the tablet terminal 101 and the image data acquired by the MFP 103 has read in a document are merged into one image data and are to be faxed. In other words, the third transmission processing significantly reduces a burdensome task in transmitting the image data generated by the tablet terminal 101 merged with the image data generated by the MFP 103.

The purpose of the third transmission processing can be achieved if both of the image data transmitted from the tablet terminal 101 and the image data acquired by scanning of the MFP 103 are transmitted from the MFP 103 through a simple operation, so that the processing in step S1013 may be omitted. Furthermore, the facsimile transmission of the image data received in step S1005 may be started before scanning is started in step S1012. In this case, the document is scanned in parallel with the transmission of the image data from the tablet terminal 101 and the image data acquired by scanning is transmitted in succession to the image data from the tablet terminal 101 (in the same call).

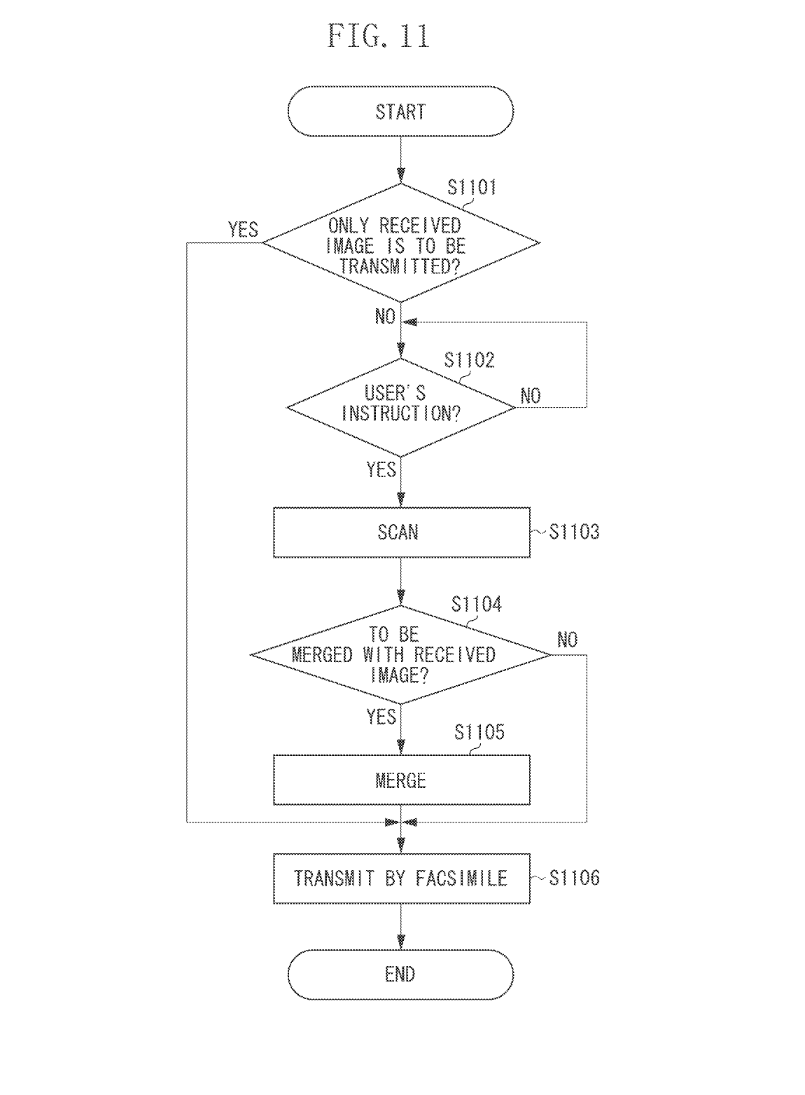

FIG. 11 is a flow chart illustrating the operation of the MFP 103. Each operation (step) illustrated in the flow chart in FIG. 11 is realized by the CPU 211 of the control unit 210 executing the control program stored in the ROM 212.

In step S1101, the CPU 211 determines the contents of the instruction from the tablet terminal 101. More specifically, if the MFP 103 receives the image transmission command but does not receive the scan command (YES in step S1101), the CPU 211 determines that the MFP 103 is instructed to fax only the image data transmitted from the tablet terminal 101 (the first transmission processing), and the processing proceeds to step S1106. In step S1106, the image data transmitted from the tablet terminal 101 are faxed.

If the MFP 103 receives the scan command (NO in step S1101), the CPU 211 determines that the MFP 103 is instructed to fax the image data acquired by scanning of the MFP 103 (the second or the third transmission processing) and the processing proceeds to step S1102. In step S1102, the CPU 211 waits for the user's instruction. If the CPU 211 receives the user's instruction (YES in step S1102), the processing proceeds to step S1103.

In step S1103, the CPU 211 operates the scanner 222 and causes the scanner 222 to read images on the document and generate image data. In step S1104, the CPU 211 determines whether the MFP 103 has received the image transmission command. If the MFP 103 has not received the image transmission command (NO in step S1104), the CPU 211 determines that the MFP 103 is instructed to fax only the image data acquired by scanning of the MFP 103 (the second transmission processing) and the processing proceeds to step S1106. In step S1106, the image data acquired by the scanning are faxed.

If the MFP 103 has received the image transmission command (YES in step S1104), the CPU 211 determines that the MFP 103 is instructed to merge and fax the image data transmitted from the tablet terminal 101 and the image data acquired by scanning (the third transmission processing), and the processing proceeds to step S1105. In step S1105, the image data transmitted from the tablet terminal 101 are merged with the image data acquired by the scanning. In step S1106, the image data merged in step S1105 are faxed.

As described above, if the tablet terminal 101 receives the instruction of the first transmission processing from the user, the tablet terminal 101 transmits the scan command to the MFP 103 (but does not transmit the image transmission command). If the MFP 103 receives the scan command but does not receive the image transmission command, the MFP 103 executes the first transmission processing. If the tablet terminal 101 receives the instruction of the second transmission processing from the user, the tablet terminal 101 transmits the image transmission command to the MFP 103 (but does not transmit the scan command). If the MFP 103 receives the image transmission command but does not receive the scan command, the MFP 103 executes the second transmission processing. If the tablet terminal 101 receives the instruction of the third transmission processing from the user, the tablet terminal 101 transmits both of the image transmission command and the scan command to the MFP 103. If the MFP 103 receives both of the image transmission command and the scan command, the MFP 103 executes the third transmission processing.

In the second and the third transmission processing, the tablet terminal 101 may transmit the image transmission commands in each job more than once. This allows the MFP 103 to collectively fax a plurality of the image data prepared by the tablet terminal 101. Similarly, in the first and the third transmission processing described above, the scan commands may be transmitted in each job more than once. This allows the MFP 103 to collectively fax a plurality of the image data acquired by multiple scan processing.

A second exemplary embodiment of the present invention is described below. In the first exemplary embodiment, when the third transmission processing is performed, the order of merging the image data transmitted from the tablet terminal 101 with the image data acquired by scanning is fixed, however, the present exemplary embodiment is different from the first exemplary embodiment in that the order can be designated by the user. The second exemplary embodiment is similar to the first exemplary embodiment in other respects, so that the description thereof is omitted.

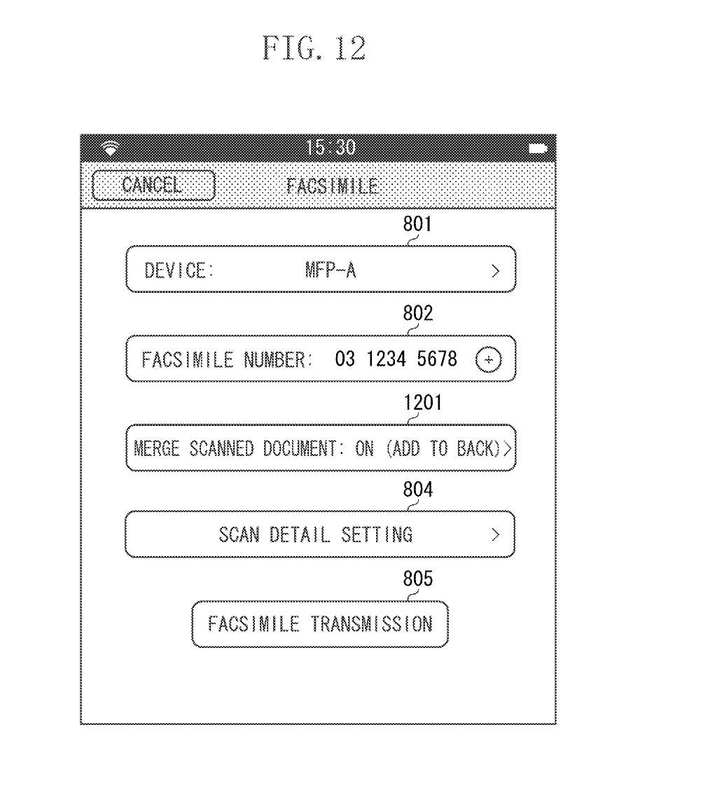

FIG. 12 illustrates an operation screen corresponding to the operation screen in FIG. 8 according to the first exemplary embodiment. The setting fields 801, 802, and 804, and the facsimile transmission key 805 are similar to those illustrated in FIG. 8. A setting field 1201 in FIG. 12 is a field where “ON (add to back),” “ON (add to front),” or “OFF” is selected, while in the setting field 803 of FIG. 8, “ON” or “OFF” is selected.

If “ON (add to back)” is set in the setting field 1201, the processing is performed according to the sequence diagram illustrated in FIG. 10. In other words, the image transmission command is transmitted in step S1005 and, thereafter, the scan command is transmitted in step S1007. As a result, the image data acquired by scanning is added to the back of the image data transmitted from the tablet terminal 101 to be merged therewith.

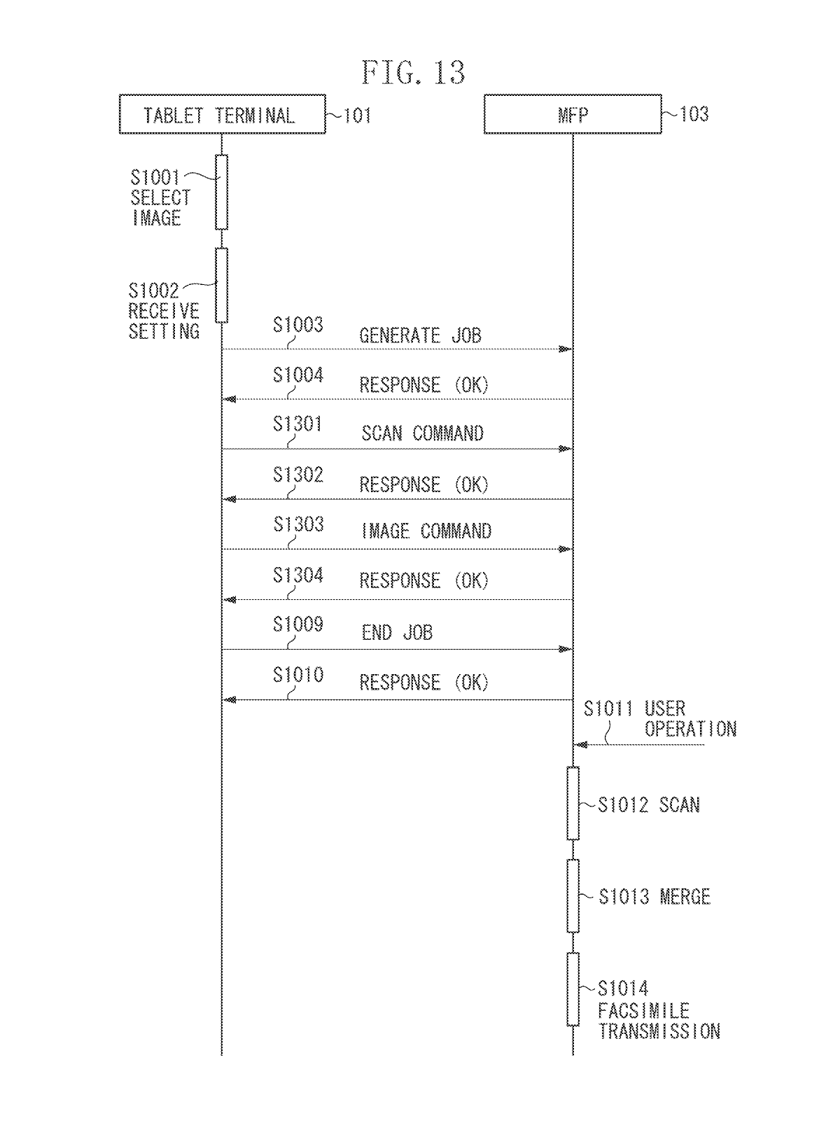

If “ON (add to front)” is set in the setting field 1201, the processing is performed according to the sequence diagram illustrated in FIG. 13. A comparison between the sequence diagrams in FIG. 13 and in FIG. 11 shows that a transmission order of the image transmission command is opposite to the scan command (steps S1301 and S1304). As a result, the image data acquired by the scanning is added to the front of the image data transmitted from the tablet terminal 101 to be merged therewith.

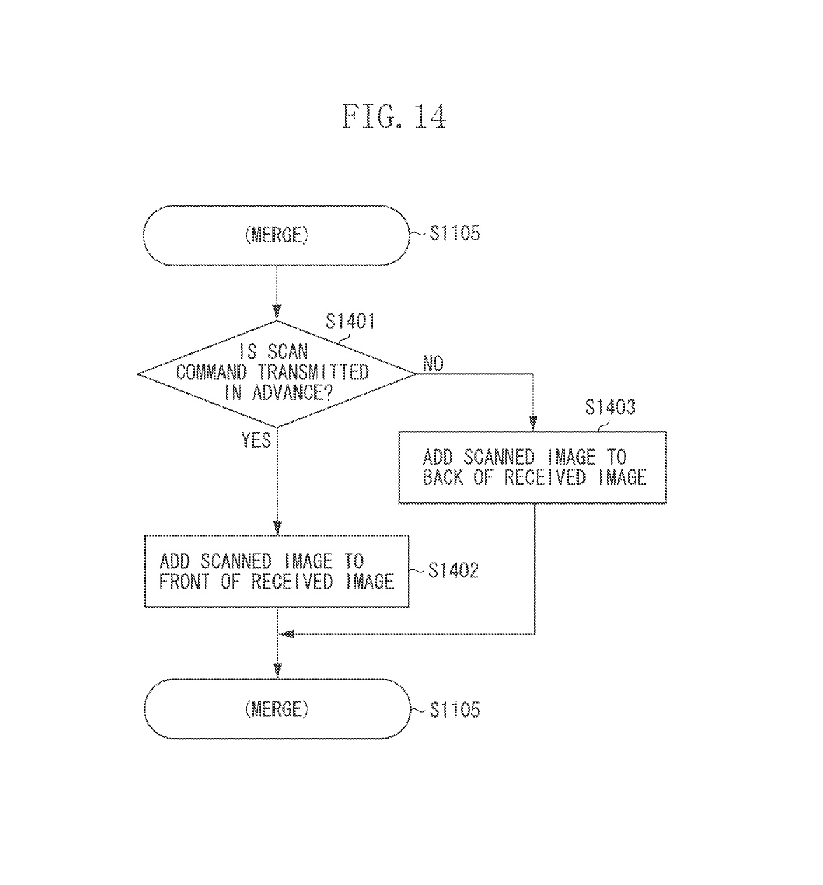

FIG. 14 is a flow chart flow chart illustrating in detail step S1105 of the flow chart illustrated in FIG. 11. In step S1401, the CPU 211 determines whether the scan command is transmitted before the image data are transmitted. If the scan command is transmitted before the image data (YES in step S1401), the processing proceeds to step S1402. If the scan command is transmitted after the image data (NO in step S1401), the processing proceeds to step S1403.

In step S1402, the scanned image data are added to the front of the image data transmitted from the tablet terminal 101 to be merged therewith. In step S1403, the scanned image data are added to the back of the image data transmitted from the tablet terminal 101 to be merged therewith.

Thus, the order of merging the image data transmitted from the tablet terminal 101 with the image data acquired by the scanning is changed according to the sequence in which the image data and the scan command are received. In other words, the order can be designated by the user on the tablet terminal 101, which further improves user friendliness.

In the above configuration, when the third transmission processing is performed, although the image data transmitted from the tablet terminal 101 merged with the image data acquired by the scanning are faxed in one outgoing call, the configuration of the third transmission processing is not limited to the above configuration. For example, independent image data may be collectively faxed as it is in one outgoing call without merging the image data transmitted from the tablet terminal 101 with the image data acquired by the scanning. Furthermore, the image data transmitted from the tablet terminal 101 and the image data acquired by the scanning may be automatically and continuously faxed in different outgoing calls respectively. If the image data transmitted from the tablet terminal 101 and the image data acquired by the scanning are collectively transmitted, this is treated in the present specification as included in the third transmission processing.

Furthermore, electronic mail, server message block (SMB), or file transfer protocol (FTP) as well as facsimile transmission may be used as a method for transmitting data from the MFP 103. If the electronic mail is used, a mail address needs to be set as an address. If the SMB or the FTP is used, a host name or a folder path of a destination server needs to be set as an address. If the electronic mail is used, the image data merged together are attached as one file to the electronic mail, a plurality of files may be attached to one electronic mail without merging the image data, or an individual file may be divided and attached to a plurality of electronic mails. If the SMB or the FTP is used, the image data merged together may be transmitted in one session as one file, a plurality of files may be transmitted in one session without merging the image data, or a divided individual file may be transmitted in a plurality of sessions.

The above description takes the MFP including the printer 221 as an example of the image processing system. If an apparatus has a scanner function, the apparatus does not necessarily need to have a printer function.

The above description takes the tablet terminal having a wireless communication function as an example of the image processing apparatus. However, if an apparatus can store image data and has a user interface communicable with the outside, another type of the apparatus may be used. For example, a personal computer (PC), a smart phone, a digital camera, or the like may be used.

Although the above description is based on a case where software processing is performed to realize the operation of each step illustrated in FIGS. 11 and 14 using the processor and the memory, a part of the steps may be processed by hardware. Further, the software and the hardware processing may be combined together to execute one step.

### Other Embodiments

Embodiments of the present invention can also be realized by a computer of a system or apparatus that reads out and executes computer executable instructions recorded on a storage medium (e.g., computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-121842 filed Jun. 10, 2013, which is hereby incorporated by reference herein in its entirety.

What is claimed is:

1. An image processing system comprising:
a reception unit configured to receive image data transmitted by an information processing apparatus;
a reading unit configured to read a document to generate image data; and
a transmission unit configured to transmit both the image data received by the reception unit and the image data generated by the reading unit, according to an instruction received by the information processing apparatus.

2. The image processing system according to claim 1, wherein the information processing apparatus is capable of receiving: a first instruction including instructions for transmitting the image data generated by the reading unit; a second instruction including instructions for transmitting the image data received by the reception unit; and a third instruction including instructions for transmitting both of the image data generated by the reading unit and the image data received by the reception unit; and
wherein the transmission unit transmits both of the image data received by the reception unit and the image data generated by the reading unit if the information processing apparatus receives the third instruction.

3. The image processing system according to claim 1, further comprising a merging unit configured to merge the image data received by the reception unit with the image data generated by the reading unit, wherein the transmission unit transmits the image data merged by the merging unit.

4. The image processing system according to claim 1, wherein the transmission unit faxes the image data received by the reception unit and the image data generated by the reading unit.

5. The image processing system according to claim 4, wherein the transmission unit faxes the image data received by the reception unit and the image data generated by the reading unit in one outgoing call.

6. The image processing system according to claim 1, wherein the information processing apparatus is capable of receiving a designated order of the image data received by the reception unit and the image data generated by the reading unit, and the transmission unit transmits the image data received by the reception unit and the image data generated by the reading unit according to the designated order received by the information processing apparatus.

7. An image processing system comprising:
a reception unit configured to receive image data;
a reading unit configured to read a document to generate image data; and
a transmission unit configured to transmit the image data received by the reception unit when a first command is received, the image data generated by the reading unit when a second command is received, and both of the image data received by the reception unit and the image data generated by the reading unit when both of the first and the second commands are received.

8. The image processing system according to claim 7, further comprising a merging unit configured to merge the image data received by the reception unit with the image data generated by the reading unit, wherein the transmission unit transmits the image data merged by the merging unit when both of the first and the second commands are received.

9. The image processing system according to claim 7, wherein the transmission unit faxes the image data received by the reception unit and the image data generated by the reading unit in one outgoing call when both of the first and the second commands are received.

10. The image processing system according to claim 7, wherein the transmission unit faxes the image data received by the reception unit and the image data generated by the reading unit, according to an order of receiving of the first and the second commands.

11. An information processing apparatus communicating with an image processing apparatus provided with a reading unit configured to read a document to generate image data, the information processing apparatus comprising:
a storage unit configured to store image data;
a receiving unit capable of receiving a first instruction including instructions for transmitting the image data generated by the reading unit, a second instruction including instructions for transmitting the image data stored in the storage unit, and a third instruction including instructions for transmitting both of the image data generated by the reading unit and the image data stored in the storage unit; and
a transmission unit configured to transmit a first command to the image processing apparatus that instructs the reading unit to execute reading processing, when the first instruction is received, a second command to the image processing apparatus that includes the image data stored in the storage unit, when the second command is received, and both of the first and the second commands to the image processing apparatus when the third instruction is received.

12. The information processing apparatus according to claim 11, wherein the receiving unit is further configured to receive a designated order of the image data generated by the reading unit and the image data stored in the storage unit when the third instruction is received.

13. The information processing apparatus according to claim 12, wherein the transmission unit transmits the first and the second commands according to the designated order when the third instruction is received.

14. An image processing method comprising:
receiving image data transmitted by an information processing apparatus;
reading a document to generate image data; and
transmitting both of the received image data and the image data generated by the reading according to an instruction received by the information processing apparatus.

15. An image processing method comprising:
receiving image data;
reading a document to generate image data; and
transmitting the received image data when a first command is received, the image data generated by the reading when a second command is received, and both of the received image data and the image data generated by the reading when both of the first and the second commands are received.

16. A method for controlling an information processing apparatus communicating with an image processing apparatus provided with a reading unit configured to read a document to generate image data, the method comprising:
storing image data in a storage unit;
first receiving of a first instruction in which instructions for transmitting the image data generated by the reading unit are given;
second receiving of a second instruction in which instructions for transmitting the image data stored in the storage unit are given;
third receiving of a third instruction in which instructions for transmitting both of the image data generated by the reading unit and the image data stored in the storage unit are given; and
transmitting a first command that instructs the reading unit to execute reading processing to the image processing apparatus when the first instruction is received, a second command, that includes the image data stored in the storage unit, to the image processing apparatus when the second instruction is received, and both of the first and the second commands to the image processing apparatus when the third instruction is received.

17. A computer readable storage medium storing computer executable instructions for causing a computer to execute an image processing method, the image processing method comprising:
receiving image data transmitted by an information processing apparatus;
reading a document to generate image data; and
transmitting both of the received image data and the image data generated by the reading, according to an instruction received by the information processing apparatus.

18. A computer readable storage medium storing computer executable instructions for causing a computer to execute an image processing method, the image processing method comprising:
receiving image data;
reading a document to generate image data; and
transmitting the received image data when a first command is received, the image data generated by the reading when a second command is received, and both of the received image data and the image data generated by the reading when both of the first and the second commands are received.

19. A computer readable storage medium storing a computer executable instructions for causing a computer to execute a method for controlling an information processing apparatus communicating with an image processing apparatus provided with a reading unit configured to read a document to generate image data, the method comprising:
storing image data in a storage unit;
first receiving of a first instruction in which instructions for transmitting the image data generated by the reading unit are given;
second receiving of a second instruction in which instructions for transmitting the image data stored in the storage unit are given;
third receiving of a third instruction in which instructions for transmitting both of the image data generated by the reading unit and the image data stored in the storage unit are given; and
transmitting a first command that instructs the reading unit to execute reading processing, to the image processing apparatus when the first instruction is received, a second command that includes the image data stored in the storage unit, to the image processing apparatus when the second instruction is received, and both of the first and the second commands, to the image processing apparatus when the third instruction is received.
